(19) United States
(12) Patent Application Publication
(10) Pub. No.: US 2023/0212050 A1
(43) Pub. Date: Jul. 6, 2023

(54) SYSTEM AND METHOD FOR SUPERSATURATING WATER WITH A GAS

(71) Applicant: Kyle Edwards Grasser, Nashville, TN (US)

(72) Inventor: Kyle Edwards Grasser, Nashville, TN (US)

(21) Appl. No.: 18/149,479

(22) Filed: Jan. 3, 2023

Related U.S. Application Data
(60) Provisional application No. 63/266,350, filed on Jan. 3, 2022.

(51) Int. Cl. C02F 9/00; A23L 2/54

(52) U.S. Cl. CPC C02F 9/00; A23L 2/54; C02F 1/001

(57) ABSTRACT

A method of producing water supersaturated with a gas includes drawing water from a water supply; filtering the water; purifying the water; disinfecting the water and neutralizing remaining biocontaminants; filtering the water to remove the neutralized biocontaminants; mineralizing the water; supersaturating the water with nanobubbles of a gas; and storing the water. A system for producing the supersaturated water includes a filter; a purification unit connected to an outlet of the filter; an ultraviolet treatment reservoir connected to an outlet of the purification unit; a second filter connected to an outlet of the UV treatment reservoir; a minerals addition unit connected to an outlet of the second filter; and a nanobubble generator connected to an outlet of the minerals addition unit. The water can be economically supersaturated at levels higher than 120%.

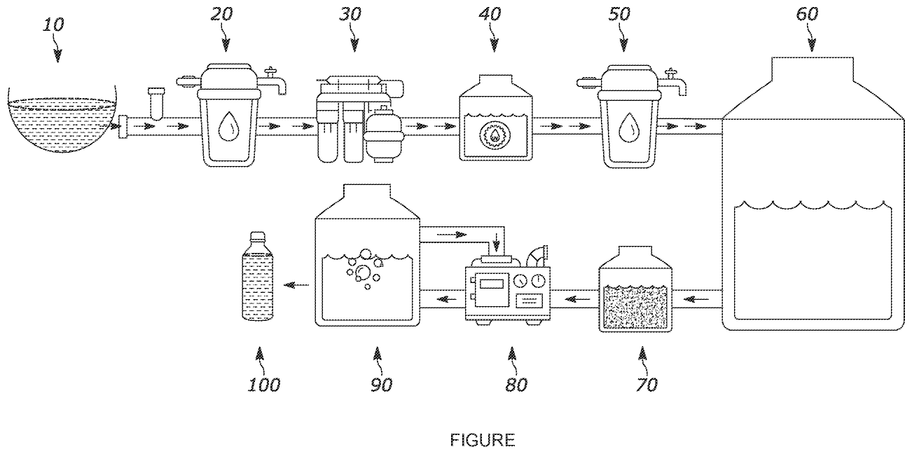

### CROSS-REFERENCE TO RELATED APPLICATION

This application claims the benefit of priority of U.S. provisional application No. 63/266,350, filed Jan. 3, 2022, the contents of which are herein incorporated by reference.

### BACKGROUND OF THE INVENTION

The present invention relates to supersaturating water with a gas and, more particularly, to a system and method therefor.

Water with a higher-than-average saturation of various gasses allows for functional water that can purify water and/or have beneficial effects on the body and plants.

Oxygen (O₂) saturation of water is calculated as a percentage of dissolved O₂ concentration relative to that when completely saturated at the temperature of the measurement. 100% saturation is defined as the equilibrium point for O₂ in the water at local barometric pressure. The temperature of water is directly related to the amount of oxygen that can be dissolved in the water as cold water can hold more gas than warm water if all other conditions are equal. Pressure and salinity also affect the saturation of O₂ in water. A number of factors can increase the saturation of O₂ in water above 100%. Rapid aeration and photosynthesis can contribute to supersaturation. Supersaturation by rapid aeration is often seen beside hydro-power dams and large waterfalls where entrained air is forced into water. Rapid temperature changes may also supersaturate water as water temperature rises and oxygen solubility decreases.

A typical prior art bottled water has anywhere from 80-120% saturation of dissolved oxygen in it. Supersaturated water may have increased health benefits and the ability to purify water. However, cost considerations prevent readily available water from being supersaturated at rates higher than 120%.

As can be seen, there is a need for dissolving various gasses into water such as nitrogen and oxygen at a higher-than-average saturation.

### SUMMARY OF THE INVENTION

In one aspect of the present invention, a method of producing water supersaturated with a gas comprises drawing water from a water supply; filtering the water; purifying the filtered water; disinfecting the purified water and neutralizing remaining biocontaminants; filtering the disinfected water to remove the neutralized remaining biocontaminants; mineralizing the filtered disinfected water; supersaturating the mineralized water iteratively with nanobubbles of a preselected gas; and storing the supersaturated water.

In another aspect of the present invention, a system for producing water supersaturated with a gas comprises a first filter operative to remove sediment and particulates; a purification unit fluidly communicating with an outlet of the first filter; an ultraviolet (UV) treatment reservoir fluidly communicating with an outlet of the purification unit; a second filter fluidly communicating with an outlet of the UV treatment reservoir; a minerals addition unit fluidly communicating with an outlet of the second filter; and a nanobubble generator fluidly communicating with an outlet of the minerals addition unit.

Without being bound by theory, water with increased oxygen content is believed to provide the human body with the ability to create more Adenosine triphosphate (ATP), which gives the cells more energy necessary to complete their functions. Supersaturated water may also be beneficial for cancer treatments and for use as a fertilizer.

These and other features, aspects and advantages of the present invention will become better understood with reference to the following drawings, description, and claims.

### BRIEF DESCRIPTION OF THE DRAWINGS

The FIGURE is a schematic view of a method of producing water supersaturated with a gas according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “fluidly communicating with” refers to a connection between units such that the unit in question receives water from a previous unit or delivers water to a following unit.

As used herein, the term “essential minerals” refers to minerals well known in the art to be necessary for human nutrition.

Broadly, one embodiment of the present invention is a system and method raising the dissolved oxygen (DO) content of water. The system and method may raise the DO of water above 120% saturation, such as to or even above 400% saturation. The present invention is not limited to the supersaturation of oxygen in water, and other gasses may be used such as hydrogen or nitrogen. Therefore, a hydrogen saturation rate above 120%, such as to or above 400%, and a nitrogen saturation rate above 120%, such as to or above 400%, are also envisioned.

The process removes general sediment and a majority of particulate from a solution such as a public water source. The water is then disinfected to remove any bio-contaminants. The neutralized bio-contaminants are then filtered from the water supply. Trace minerals may be added back into the water to obtain an alkaline pH and/or to improve taste, for example. The water is then supersaturated with nanobubbles.

The water must be purified before treatment with the nanobubbles to stabilize the dissolved gas, enabling nanoscale bubbles to remain suspended in the solution. Any suitable purification method known in the art may be used, such as reverse osmosis (i.e., ion exchange) and/or boiling water and condensing the water vapor in a vaporization and condensation unit.

The steps to purify the water may be interchanged. For example, the water may be disinfected before a filter removes sediment and particulate from the water. Any suitable disinfection method known in the art may be used, such as ultraviolet (UV) light application.

In some embodiments, trace minerals such as calcium, magnesium, potassium, and other essential minerals that affect the pH level may be added to the filtered water prior to supersaturation.

Referring to the sole FIGURE, the FIGURE illustrates a method of producing water supersaturated with a gas according to an embodiment of the present invention and the system components therefor. Each unit described herein has an inlet and an outlet. Water drawn from a water supply 10 may be passed through a first filter 20 to remove sediment and particulates. The filtered water may be subjected to a reverse osmosis system 30 to remove most remaining contaminants. The water may be disinfected in a UV treatment reservoir 40 which may also neutralize any remaining biocontaminants. A second filter 50 may be used to remove any neutralized biocontaminants in the disinfected water. The purified water may be stored in a pure water reservoir 60. The purified water may undergo mineralization in a minerals addition unit 70 to restore necessary minerals previously removed, e.g., for nutrition and/or taste, and/or to achieve a predetermined pH. The remineralized water may be iteratively processed through a nanobubble generator 80 with a recirculating nanobubble water tank 90 until a predetermined level of saturation of a preselected gas such as oxygen, nitrogen, or hydrogen, is achieved. The supersaturated water may then be stored, e.g., in a bottle 100, for later use. The water bottle 100 may be shipped to consumers, making water supersaturated with a gas readily available.

It should be understood, of course, that the foregoing relates to exemplary embodiments of the invention and that modifications may be made without departing from the spirit and scope of the invention as set forth in the following claims.

What is claimed is:

1. A method of producing water supersaturated with a gas, comprising:
drawing water from a water supply;
filtering the water;
purifying the filtered water;
disinfecting the purified water and neutralizing remaining biocontaminants; filtering the disinfected water to remove the neutralized remaining biocontaminants;
mineralizing the filtered disinfected water;
supersaturating the mineralized water iteratively with nanobubbles of a preselected gas; and
storing the supersaturated water.

2. The method of claim 1, wherein the supersaturated water has an oxygen saturation rate of at least about 120%.

3. The method of claim 1, wherein the supersaturated water has a hydrogen saturation rate of at least about 120%.

4. The method of claim 1, wherein the supersaturated water has a nitrogen saturation rate of at least about 120%.

5. The method of claim 1, wherein the purifying comprises ion exchange and/or boiling and condensing.

6. A system for producing water supersaturated with a gas, comprising:
a first filter operative to remove sediment and particulates;
a purification unit fluidly communicating with an outlet of the first filter;
an ultraviolet (UV) treatment reservoir fluidly communicating with an outlet of the purification unit;
a second filter fluidly communicating with an outlet of the UV treatment reservoir;
a minerals addition unit fluidly communicating with an outlet of the second filter; and
a nanobubble generator fluidly communicating with an outlet of the minerals addition unit.

7. The system of claim 6, wherein the purification unit comprises a reverse osmosis unit and/or a vaporization and condensation unit.

8. The system of claim 6, further comprising a pure water reservoir positioned between the second filter and the minerals addition unit and fluidly communicating with the outlet of the second filter and an intake of the minerals addition unit.

9. The system of claim 6, wherein the nanobubble generator further comprises a recirculating nanobubble water tank.
